(19) United States
(12) Patent Application Publication
(10) Pub. No.: US 2024/0212015 A1
(43) Pub. Date: Jun. 27, 2024

(54) PROCESSING METHOD AND APPARATUS FOR CUSTOMIZING HOME APPLIANCE SET, ELECTRONIC DEVICE AND STORAGE MEDIUM

(71) Applicants: COSMO INSTITUTE OF INDUSTRIAL INTELLIGENCE (QINGDAO) CO., LTD., Qingdao, Shandong (CN); COSMO DIGITAL TECHNOLOGY (QINGDAO) CO., LTD., Qingdao, Shandong (CN); COSMO IOT TECHNOLOGY CO., LTD., Qingdao, Shandong (CN)

(72) Inventors: Yong WANG, Shandong (CN); Heyan LIU, Shandong (CN); Hui GUO, Shandong (CN)

(21) Appl. No.: 18/288,551

(22) PCT Filed: Sep. 7, 2022
(86) PCT No.: PCT/CN2022/117594

§ 371 Date: Oct. 26, 2023

(30) Foreign Application Priority Data
Dec. 31, 2021 (CN) 202111674085.8

(51) Int. Cl. G06Q 30/0601

(52) U.S. Cl. CPC G06Q 30/0621

(57) ABSTRACT

Provided is a processing method for customizing a home appliance set, including: obtaining user related information; creating a home appliance set portrait according to the user related information; calculating a similarity between target label information corresponding to each of types for home appliances to be customized in the home appliance set portrait, and home appliance label information of each of home appliances in a preset home appliance label library, and obtaining from the home appliance label library, according to the similarity, a target home appliance corresponding to each of the types; modifying customizable information of each of target home appliances to obtain target home appliance label information as modified; combining all of the target home appliances to obtain a home appliance set as combined, and outputting each of the target home appliances in the home appliance set and the corresponding target home appliance label information.

This application is a National Stage of International Application No. PCT/CN2022/117594, filed on Sep. 7, 2022, which claims priority to Chinese Patent Application No. 202111674085.8, filed on Dec. 31, 2021. Both of the applications are hereby incorporated by reference in their entireties.

### TECHNICAL FIELD

Embodiments of the present application belongs to the field of home appliance technologies, specifically, to a processing method and apparatus for customizing a home appliance set, an electronic device and a storage medium.

### BACKGROUND

In the context of intelligent producing and intelligent life, the traditional mode of mass production for mass orders can no longer meet the increasing requirements of customers for home appliance products. Therefore, many household appliance enterprises begin to provide customized services to meet the personalized requirements of users.

At present, the practice of customizing a home appliance product mainly involves collecting, by a home appliance enterprise, personalized requirements of users by means of questionnaires or product evaluation, etc., classifying the users according to the personalized requirements of the respective users, performing analysis on each type of users, generalizing a common requirement of each type of users, and designing a home appliance product according to the common requirement of each type of users, thereby achieving the customization of the home appliance product.

However, in prior arts, only customization for an individual home appliance is realized, and a home appliance set cannot be customized according to an actual living scenario of a user, thus, there may exist a problem that accuracy for home appliance customization is low.

### SUMMARY

To address the foregoing problem in the prior art, namely, to address the problem which may exist in the prior art that only customization for an individual home appliance is realized, and a home appliance set cannot be customized according to an actual living scenario of a user, thus, accuracy for home appliance customization is low, embodiments of the present application provide a processing method and apparatus for customizing a home appliance set, an electronic device and a storage medium.

In a first aspect, an embodiment of the present application provides a processing method for customizing a home appliance set, including:
obtaining user related information, where the user related information includes a preset budget, at least two types for home appliances to be customized, question information of a user for each of the types for the home appliances to be customized, and requirement information of the user for each of the types for the home appliances to be customized;
creating a home appliance set portrait of the user according to the user related information, where the home appliance set portrait includes the at least two types for the home appliances to be customized and at least one piece of target label information corresponding to each of the types for the home appliances to be customized;
calculating a similarity between the target label information corresponding to each of the types for the home appliances to be customized in the home appliance set portrait, and home appliance label information of each of home appliances in a preset home appliance label library, and obtaining from the home appliance label library, according to the similarity, a target home appliance corresponding to each of the types for the home appliances to be customized, where the home appliance label library includes multiple home appliances and the home appliance label information corresponding to each of the home appliances, where the home appliance label information includes budget information, function information, size information, appearance information and brand information, where at least one of the function information, the size information and the appearance information is customizable information;
modifying, according to the requirement information, customizable information of each of target home appliances to obtain target home appliance label information, as modified, of each of the target home appliances; and
combining all of the target home appliances to obtain a home appliance set as combined, and outputting each of the target home appliances in the home appliance set and the corresponding target home appliance label information.

In a preferred technical solution of the foregoing processing method for customizing a home appliance set, the user related information further includes a historical order for each of the types for the home appliances to be customized, a browsing record for each of the types for the home appliances to be customized, evaluation data of the user for each of the types for the home appliances to be customized, location information of the user, and house layout data of a residential house of the user;
correspondingly, creating the home appliance set portrait of the user according to the user related information, includes:
performing emotion analysis on the question information and the requirement information for each of the types for the home appliances to be customized, to obtain emotion analysis grades for the types for the home appliances to be customized;
obtaining, according to an emotion analysis grade for each of the types for the home appliances to be customized and the evaluation data, preference information of the user for the types for the home appliances to be customized;
generating target label information corresponding to the types for the home appliances to be customized, according to preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user; and
creating, according to each of the types for the home appliances to be customized and the corresponding target label information, the home appliance set portrait of the user.

In a preferred technical solution of the foregoing processing method for customizing a home appliance set, generating the target label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user, includes:
generating initial label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user;
obtaining, according to historical sales data of individual home appliances of each of the types for the home appliances to be customized and the initial label information, a selling popularity index corresponding to each piece of sub-label information in each piece of initial label information; and
processing the initial label information according to the selling popularity index corresponding to each piece of sub-label information in each piece of initial label information, to generate the target label information.

In a preferred technical solution of the foregoing processing method for customizing a home appliance set, obtaining from the home appliance label library, according to the similarity, the target home appliance corresponding to each of the types for the home appliances to be customized, includes:
determining a home appliance corresponding to the home appliance label information with the similarity exceeding a preset similarity to be the target home appliance.

In a preferred technical solution of the foregoing processing method for customizing a home appliance set, when a number of the target home appliances is greater than or equal to 2, combining all of the target home appliances to obtain the home appliance set as combined, includes:
for the types for the home appliances to be customized that are different, determining any one target home appliance in each of the types for the home appliances to be customized to be a home appliance to be combined; and
combining all of home appliances to be combined to obtain multiple home appliance sets as combined.

In a preferred technical solution of the foregoing processing method for customizing a home appliance set, before obtaining the user related information, the method further includes:
obtaining initial question information of the user for each of the types for the home appliances to be customized and initial requirement information of the user for each of the types for the home appliances to be customized; and
performing data cleaning and data normalization processing on the initial question information and the initial requirement information to obtain the question information and the requirement information.

In a preferred technical solution of the foregoing processing method for customizing a home appliance set, outputting each of the target home appliances in the home appliance set and the corresponding target home appliance label information, includes:
displaying, through a visual interface, each of the target home appliances in the home appliance set and the corresponding target home appliance label information.

In a second aspect, an embodiment of the present application provides a processing apparatus for customizing a home appliance set, including:
an obtaining module, configured to obtain user related information, where the user related information includes a preset budget, at least two types for home appliances to be customized, question information of a user for each of the types for the home appliances to be customized, and requirement information of the user for each of the types for the home appliances to be customized;
a creating module, configured to create a home appliance set portrait of the user according to the user related information, where the home appliance set portrait includes the at least two types for the home appliances to be customized and at least one piece of target label information corresponding to each of the types for the home appliances to be customized; and
a processing module, configured to calculate a similarity between the target label information corresponding to each of the types for the home appliances to be customized in the home appliance set portrait, and home appliance label information of each of home appliances in a preset home appliance label library, and obtain from the home appliance label library, according to the similarity, a target home appliance corresponding to each of the types for the home appliances to be customized, where the home appliance label library includes multiple home appliances and the home appliance label information corresponding to each of the home appliances, where the home appliance label information includes budget information, function information, size information, appearance information and brand information, where at least one of the function information, the size information and the appearance information is customizable information;
where the processing module is further configured to: modify, according to the requirement information, customizable information of each of target home appliances to obtain target home appliance label information, as modified, of each of the target home appliances; and
the processing module is further configured to: combine all of the target home appliances to obtain a home appliance set as combined, and output each of the target home appliances in the home appliance set and the corresponding target home appliance label information.

In a preferred technical solution of the foregoing processing apparatus for customizing a home appliance set, the user related information further includes a historical order for each of the types for the home appliances to be customized, a browsing record for each of the types for the home appliances to be customized, evaluation data of the user for each of the types for the home appliances to be customized, location information of the user, and house layout data of a residential house of the user;
correspondingly, the creating module is specifically configured to:
   perform emotion analysis on the question information and the requirement information for each of the types for the home appliances to be customized, to obtain emotion analysis grades for the types for the home appliances to be customized;
   obtain, according to an emotion analysis grade for each of the types for the home appliances to be customized and the evaluation data, preference information of the user for the types for the home appliances to be customized;
   generate target label information corresponding to the types for the home appliances to be customized, according to preference information for each of types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user; and
   create, according to each of the types for the home appliances to be customized and the corresponding target label information, the home appliance set portrait of the user.

In a preferred technical solution of the foregoing processing apparatus for customizing a home appliance set, the creating module is specifically configured to:
generate initial label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user;
obtain, according to historical sales data of individual home appliances of each of the types for the home appliances to be customized and the initial label information, a selling popularity index corresponding to each piece of sub-label information in each piece of initial label information; and
process the initial label information according to the selling popularity index corresponding to each piece of sub-label information in each piece of initial label information, to generate the target label information.

In a preferred technical solution of the foregoing processing apparatus for customizing a home appliance set, the processing module is specifically configured to:
determine a home appliance corresponding to the home appliance label information with the similarity exceeding a preset similarity to be the target home appliance.

In a preferred technical solution of the foregoing processing apparatus for customizing a home appliance set, when a number of the target home appliances is greater than or equal to 2, the processing module is specifically configured to:
for the types for the home appliances to be customized that are different, determine any one target home appliance in each of the types for the home appliances to be customized to be a home appliance to be combined; and
combine all of home appliances to be combined to obtain multiple home appliance sets as combined.

In a preferred technical solution of the foregoing processing apparatus for customizing a home appliance set, before obtaining the user related information, the obtaining module is further configured to: obtain initial question information of the user for each of the types for the home appliances to be customized and initial requirement information of the user for each of the types for the home appliances to be customized; and
the processing module is further configured to: perform data cleaning and data normalization processing on the initial question information and the initial requirement information to obtain the question information and the requirement information.

In a preferred technical solution of the foregoing processing apparatus for customizing a home appliance set, the processing module is specifically configured to: display, through a visual interface, each of the target home appliances in the home appliance set and the corresponding target home appliance label information.

In a third aspect, an embodiment of the present application provides an electronic device, including a processor and a memory and computer program instructions stored on the memory and capable of running on the processor; where the computer program instructions are configured to, when being executed by the processor, implement the method according to the first aspect and various possible designs.

In a fourth aspect, an embodiment of the present application provides a computer-readable storage medium, storing thereon computer executable instructions which are configured to, when being executed by a processor, implement the method according to the first aspect and various possible designs.

In a fifth aspect, an embodiment of the present application provides a computer program product, including a computer program, where the computer program is configured to, when being executed by a processor, implement the method according to the first aspect and various possible designs.

In a sixth aspect, an embodiment of the present application provides a chip including a memory and a processor, the memory storing thereon codes and data, and being coupled to the processor, where the processor runs a program in the memory to implement the method according to the first aspect and various possible designs.

In a seventh aspect, an embodiment of the present application provides a computer program, where the computer program is configured to, when being executed by a processor, implement the method according to the first aspect and various possible designs.

Those skilled in the art can understand that, a processing method and apparatus for customizing a home appliance set, an electronic device and a storage medium are provided in the embodiments of the present application. The method includes: obtaining user related information; creating a home appliance set portrait of the user according to the user related information; calculating a similarity between the target label information corresponding to each of the types for the home appliances to be customized in the home appliance set portrait, and home appliance label information of each of home appliances in a preset home appliance label library, and obtaining from the home appliance label library, according to the similarity, a target home appliance corresponding to each of the types for the home appliances to be customized; modifying, according to the requirement information, customizable information of each of target home appliances to obtain target home appliance label information, as modified, of each of the target home appliances; combining all of the target home appliances to obtain a home appliance set as combined, and outputting each of the target home appliances in the home appliance set and the corresponding target home appliance label information. The presented solution can obtain user requirement information accurately, and improve accuracy and speed effectively for generating a home appliance set, thereby, satisfying a customization requirement of a user and providing, for various industries, more comprehensive and efficient support for marketing and iterative research and development.

### BRIEF DESCRIPTION OF DRAWINGS

A processing method and apparatus for customizing a home appliance set, an electronic device and a storage medium will be described in the following in conjunction with the accompanying drawings. The accompanying drawings are described as follows.

FIG. TA is a schematic diagram of an application scenario of a processing method for customizing a home appliance set according to an embodiment of the present application.

FIG. TB is a schematic structural diagram of a server for configuring a home appliance set according to an embodiment of the present application.

FIG. 2 is a schematic flowchart in a first embodiment of a processing method for customizing a home appliance set according to an embodiment of the present application.

FIG. 3A is a schematic diagram in a first embodiment of a visual interface according to an embodiment of the present application.

FIG. 3B is a schematic diagram in a second embodiment of a visual interface according to an embodiment of the present application.

FIG. 4 is a schematic coordinate diagram of an air key performance indicator method according to an embodiment of the present application.

FIG. 5 is a schematic flowchart in a second embodiment of a processing method for customizing a home appliance set according to an embodiment of the present application.

FIG. 6 is a schematic flowchart in a third embodiment of a processing method for customizing a home appliance set according to an embodiment of the present application.

FIG. 7 is a schematic structural diagram of a processing apparatus for customizing a home appliance set according to an embodiment of the present application.

FIG. 8 is a schematic structural diagram of an electronic device according to an embodiment of the present application.

### DESCRIPTION OF EMBODIMENTS

Firstly, those skilled in the art should understand that the embodiments are only used to explain the technical principles of the present application and are not intended to limit the protection scope of the present application. Those skilled in the art can make modifications to them as needed to fit a specific application scenario.

Secondly, it should be noted that in the description of the embodiments of the present application, a directional or positional relationship indicated by a term “inside”, “outside” or the like is based on a directional or positional relationship as shown in the accompanying drawings, which is only for the convenience of description, instead of an indication or an implication that the apparatus or the component must have a specific orientation, be constructed or operated in a specific orientation, and therefore should not be interpreted as a limitation to the present application.

In addition, it should be noted that in the description of the embodiments of the present application, unless otherwise specified and limited, the term “connected” or “connection” should be interpreted in a broad sense, for example, it can be a fixed connection, a detachable connection, or an integrated connection; it can be a mechanical connection, or an electrical connection; it can be a direct connection, or an indirect connection through an intermediate medium, or it can be an internal connection of two components. For those skilled in the art, a specific meaning of the mentioned term in the embodiments of the present application can be interpreted according to a specific situation.

In order to make objectives, technical solutions and advantages of the embodiments of the present application clearer, the following will describe the technical solution of the embodiments of the present application clearly and comprehensively, in conjunction with the accompanying drawings in the embodiments of the present application. Apparently, the described embodiments are part rather than all of the embodiments of the present application. Based on the embodiments of the present application, all the other embodiments obtained by those ordinarily skilled in the art without creative efforts are within the protection scope of the present application.

Firstly, before introducing the embodiments of the present application, an application context of embodiments of the present application is explained as follows.

In the context of the rapid development of the Fourth Industrial Revolution (also known as Industry 4.0) and intelligent manufacturing, neither enterprises nor users are outsiders. The enterprises will no longer be the only initiator of production and manufacturing activities, and the role of the initiator will shift to the users. In other words, the enterprise-driven producing mode is about to transform into a user-driven mode. Therefore, traditional enterprises will face opportunities and challenges for enterprise transformation.

Nowadays, many home appliance enterprises are beginning to provide customized services, which combines the advantages of customization and mass production, makes personalized customization possible for users. The enterprises can provide personalized designs and customized services to the users better, faster, and more accurately, and meet their diverse requirements, which improves user experience, and also ensures that home appliance products are mass produced.

At present, the practice of customizing a home appliance product mainly involves collecting, by a home appliance enterprise, personalized requirements of users by means of questionnaires or product evaluation, etc., classifying the users according to the personalized requirements of each user, performing analysis on each type of users, generalizing a common requirement of each type of users, and designing a home appliance product according to the common requirement of each type of users, thereby achieving the customization of the home appliance product.

However, in prior arts, only customization for an individual home appliance is realized, and a home appliance set cannot be customized according to an actual living scenario of a user, thus, there may exist a problem of low accuracy for home appliance customization.

Regarding the foregoing problem, the inventive concept of the present application is as follows: an electronic device can obtain user related information; and create a home appliance set portrait according to at least two types for home appliances to be customized in the user related information. Thereby, it can calculate a similarity between a home appliance set and a preset home appliance label library, determine, according to the similarity, target home appliances from the home appliance label library; modify, according to requirement information in the user related information, customizable information of the target home appliances; and eventually, combine all of the determined target home appliances, such that home appliance sets as combined are obtained and the problem in the prior art that the accuracy for home appliance customization is low is solved. Thereby, a user is enabled to obtain home appliance sets that satisfy his/her own requirements, and using experience of the user is improved.

As an example, a processing method for customizing a home appliance set according to an embodiment of the present application may be applied to an application scenario as shown in a schematic diagram of FIG. TA. FIG. TA is a schematic diagram of an application scenario of a processing method for customizing a home appliance set according to an embodiment of the present application, which is used to address the foregoing technical problem. As shown in FIG. TA, the application scenario may include: an engine 11 for configuring a home appliance set, a terminal device 12, and a home appliance label library 13.

Among them, the engine 11 for configuring a home appliance set includes a customization platform 111, a product platform 112, a business-to-business (Business-to-Business, B2B) platform 113, a server 114 for configuring a home appliance set, an ecological manufacturer platform 115, and a third-party user interface 116.

A step further, FIG. 1B is a schematic structural diagram of a server for configuring a home appliance set according to an embodiment of the present application. As shown in FIG. 1B, the server 114 for configuring a home appliance set includes: a house layout center servicer 141, a product center 142, a data analysis center 143, a search engine 144, a matching data analyzer 145, and a user behavior analyzer 146. Through a service mode developed with a software development kit (Software Development Kit, SDK) in an embedded and semi-customized manner, a docking service of multi-front-end, multi-entrance and multi-community contact is realized.

In FIG. TA, the terminal device 12 displays a visual interface on a screen by running software or a browser, so that it is conducive for a user to interact with the terminal device 12 through an operation to the visual interface. The terminal device 12 obtains the user related information by responding to the user's operation to the visual interface, and sends the user related information to the server 114 for configuring a home appliance set.

A step further, the server 114 for configuring a home appliance set receives the user related information sent by the terminal device 12, and creates a home appliance set portrait of the user according to the user related information. Subsequently, according to the home appliance set portrait and the home appliance label library 13, it obtains multiple target home appliances from the home appliance label library 13, and modifies home appliance label information of the target home appliances to obtain target home appliance label information as modified. Eventually, it sends each of the target home appliances and corresponding target home appliance label information to the terminal device 12.

A step further, the terminal device 12 receives and displays through the visual interface, each of the target home appliances and the corresponding target home appliance label information sent by the server 114 for configuring a home appliance set. The terminal device 12 sends a confirmation instruction to the server 114 for configuring a home appliance set in response to the user's click operation to a confirmation control on the visual interface. Upon receiving the confirmation instruction sent by the terminal device 12, the server 114 for configuring a home appliance set, according to each of the target home appliances and the corresponding target home appliance label information, interacts with the customization platform 111, the ecological manufacturer platform 115 and the third-party user interface 116, in order to facilitate the subsequent producing activities of the home appliance set.

In the technical solution of the present disclosure, the processing of a user's personal information, such as collection, storage, use, machining, transmission, provision and disclosure, comply with the provisions of related laws and regulations and does not offend public order and good morals.

In a practical application, as a terminal device is also a processing device with data processing capabilities, the server for configuring a home appliance set in the foregoing application scenario as shown in FIG. TA and FIG. 1B can also be implemented by the terminal device. In an embodiment of the present application, the server for configuring a home appliance set and the terminal device for data processing can be referred to as an electronic device in general.

In the following, the technical solutions of the present application will be explained in detail with specific embodiments.

It should be noted that, the following specific embodiments may be combined with each other, and a same or similar concept or process may not be repeated in some embodiments.

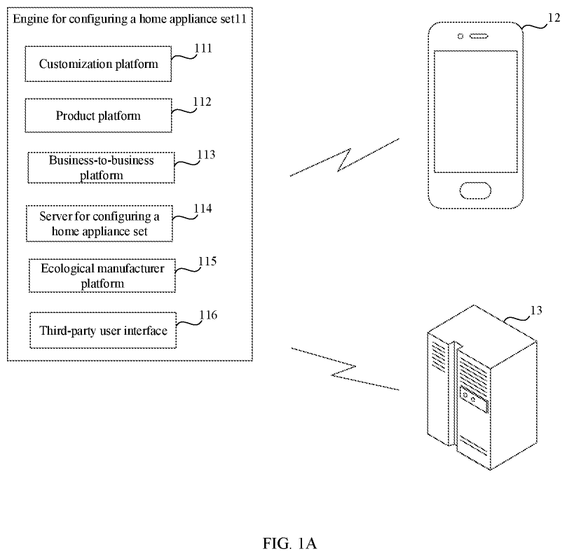

FIG. 2 is a schematic flowchart in a first embodiment of a processing method for customizing a home appliance set according to an embodiment of the present application. As show in in FIG. 2, the processing method for customizing a home appliance set may include the following steps.

S21, obtaining user related information.

The user related information includes a preset budget, at least two types for home appliances to be customized, question information of a user for each of the types for the home appliances to be customized, and requirement information of the user for each of the types for the home appliances to be customized.

As an example, the types for the home appliances to be customized may include a refrigerator type, an air conditioner type, a washing machine type, a clothes dryer type, a water heater type, a kitchen appliance type, etc., or may include other types for home appliances that exist in prior arts, which can be determined based on an actual situation and thus is not specifically limited in the embodiments of the present application.

In an implementation, the requirement information includes a brand requirement, a functional requirement, a security monitoring requirement, an ecological requirement for water, an ecological requirement for temperature, an ecological requirement for air, etc.

In an implementation, the user related information further includes a historical order for each of the types for the home appliances to be customized, a browsing record for each of the types for the home appliances to be customized, evaluation data of the user for each of the types for the home appliances to be customized, location information of the user, and house layout data of a residential house of the user.

The house layout data includes a house layout style, a house size, usage of a house, and a resident population structure.

An electronic device can display a visual interface on a screen by means of running software or a browser, so as to receive the user related information input by the user through the visual interface. The electronic device can also obtain the user related information through a network, permitting the electronic device to perform processing on the user related information subsequently.

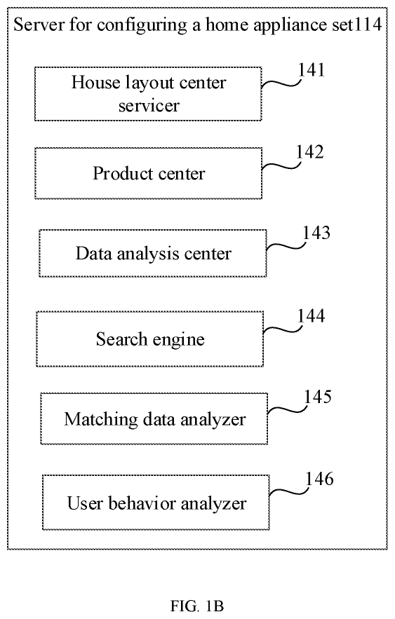

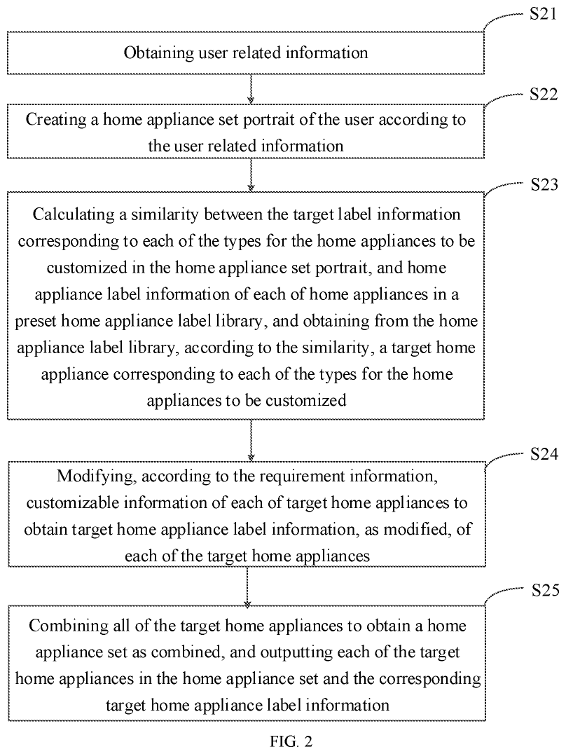

FIG. 3A is a schematic diagram in a first embodiment of a visual interface according to an embodiment of the present application. As shown in FIG. 3A, the visual interface includes a bedroom quantity control, a living room quantity control, a preset budget control, a control for the types for the home appliances to be customized, a resident quantity control, a control for whether there is an elderly, a control for whether there is a child, a location information control, and a requirement information control for each of the types for the home appliances to be customized.

FIG. 3B is a schematic diagram in a second embodiment of a visual interface according to an embodiment of the present application. As shown in FIG. 3B, the visual interface includes a house layout data control, a location information control, and a control for the types for the home appliances to be customized.

In an implementation, the electronic device can receive initial question information of the user for each of the types for the home appliances to be customized and initial requirement information of the user for each of the types for the home appliances to be customized, where both information is input by the user. It can also obtain the initial question information and the initial requirement information through a network, and perform data cleaning and data normalization processing on the initial question information and the initial requirement information to obtain the question information and the requirement information. That is, the electronic device can perform data cleaning and data normalization processing on the obtained initial question information and the obtained initial requirement information to eliminate content data that is irrelevant to questions and requirements. Thereby, the question information and the requirement information that have undergone the processing are obtained, so as to improve efficiency and accuracy for the following processing.

S22, creating a home appliance set portrait of the user according to the user related information.

The home appliance set portrait includes the at least two types for the home appliances to be customized and at least one piece of target label information corresponding to each of the types for the home appliances to be customized.

In an implementation, upon obtaining the user related information, the electronic device can perform processing on the user related information to obtain target label information corresponding to each of the types for the home appliances to be customized in the user related information, and create, according to each of the types for the home appliances to be customized and the corresponding target label information, the home appliance set portrait of the user.

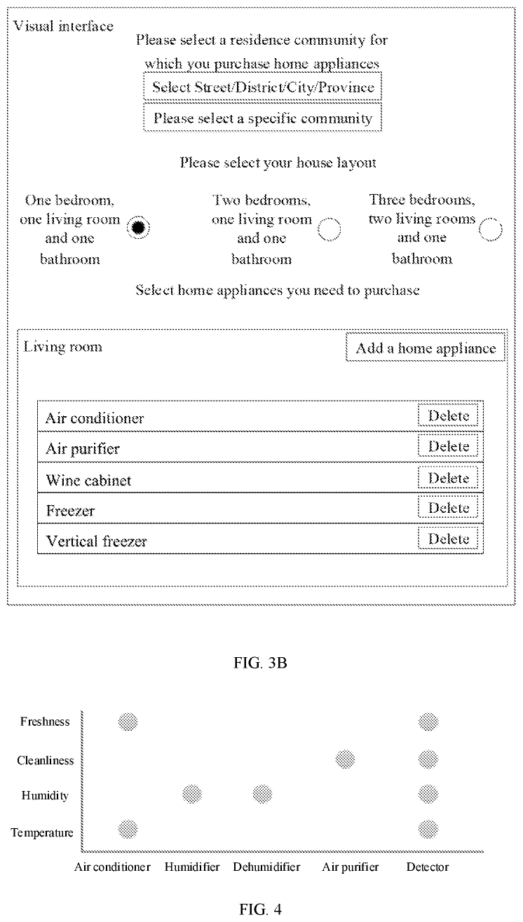

In an implementation, for the specific implementation principle of this step, reference can be made to the description of the embodiment as shown in FIG. 5 as follows, which will not be elaborated here.

S23, calculating a similarity between the target label information corresponding to each of the types for the home appliances to be customized in the home appliance set portrait, and home appliance label information of each of home appliances in a preset home appliance label library, and obtaining from the home appliance label library, according to the similarity, a target home appliance corresponding to each of the types for the home appliances to be customized.

The similarity between the target label information corresponding to each of the types for the home appliances to be customized in the home appliance set portrait, and the home appliance label information of each of the home appliances in the preset home appliance label library, can be calculated per user with each of the types for the home appliances to be customized as a calculation dimension, using the Pearson correlation coefficient (Pearson correlation coefficient) algorithm, the Cosine-based Similarity (Cosine-based Similarity) algorithm, or other existing algorithms.

A step further, the target home appliance(s) corresponding to each of the types for the home appliances to be customized can be obtained from the home appliance label library according to the similarity through the following manners:
1) determining a home appliance with the highest similarity corresponding to each of the types for the home appliances to be customized to be a target home appliance;
2) determining a home appliance corresponding to the home appliance label information with the similarity exceeding a preset similarity to be the target home appliance. The diversity of the subsequent home appliance sets as combined can be effectively improved, thereby, providing more optional diversified home appliance set solutions for the user, and improving user experience and processing accuracy for customizing a home appliance set.

As an example, the preset similarity may be 70%, 80%, 90%. The preset similarity may also be determined based on an actual situation and thus is not specifically limited in the embodiments of the present application.

The home appliance label library includes multiple home appliances and the home appliance label information corresponding to each of the home appliances. The home appliance label information includes budget information, function information, size information, appearance information and brand information, where at least one of the function information, the size information and the appearance information is customizable information.

As an example, the home appliances in the home appliance label library and the corresponding label information may be as presented in Table 1.

TABLE 1

| Home | | | | | | | |
|---|---|---|---|---|---|---|---|
| appliance | Home | Function | Size | Appearance | Brand | Budget | Customizable |
| types | appliance | information | information | information | information | information | information |
| Clothes | Clothes | Function 1 | Size 1 | Appearance | Brand 1 | Budget 1 | Function and |
| dryer type | dryer 1 | | | 1 | | | size |
| | Clothes | Function 2 | Size 2 | Appearance | Brand 2 | Budget 2 | Size and |
| | dryer 2 | | | 2 | | | appearance |
| Air | Air | Function 3 | Size 3 | Appearance | Brand 3 | Budget 3 | Appearance |
| conditioner | conditioner | | | 3 | | | |
| type | 1 | | | | | | |
| | Air | Function 4 | Size 4 | Appearance | Brand 4 | Budget 4 | Function |
| | conditioner | | | 4 | | | |
| | 2 | | | | | | |
| Washing | Washing | Function 5 | Size 5 | Appearance | Brand 5 | Budget 5 | Function and |
| machine | machine 1 | | | 5 | | | appearance |
| type | Washing | Function 6 | Size 6 | Appearance | Brand 6 | Budget 6 | Size |
| | machine 2 | | | 6 | | | |

As an example, as shown in Table 1, in the home appliance label library, the label information corresponding to a home appliance may further include a volume, energy consumption, suitable space, whether intelligent control is supported, and other information, which may be defined based on an actual situation and thus is not specifically limited in the embodiments of the present application.

S24, modifying, according to the requirement information, customizable information of each of target home appliances to obtain target home appliance label information, as modified, of each of the target home appliances.

As an example, with reference to the home appliance label library as presented in Table 1, the target home appliances are the clothes dryer 2 and the air conditioner 2, in the requirement information, the appearance for a clothes dryer type is black, and the appearance for an air conditioner type is white. Thus, according to the requirement information, modify the color of the clothes dryer 2 as black and modify the color of the air conditioner 2 as white.

S25, combining all of the target home appliances to obtain a home appliance set as combined, and outputting each of the target home appliances in the home appliance set and the corresponding target home appliance label information.

In an implementation, all of the target home appliances may be combined through the Top-N algorithm and association rules to obtain home appliance sets as combined.

In a specific implementation, if each of the types for the home appliances to be customized corresponds to one target home appliance, all of the target home appliances are directly combined to obtain the home appliance set as combined.

In another specific implementation, when a number of the target home appliances corresponding to the types for the home appliances to be customized is greater than or equal to 2, for the types for the home appliances to be customized that are different, determine any one target home appliance in each of the types for the home appliances to be customized to be a home appliance to be combined; and combine all of home appliances to be combined to obtain multiple home appliance sets as combined, thereby, providing more optional diversified home appliance set solutions for the user, and improving user experience and the accuracy for generating home appliance sets.

As an example, with reference to the home appliance label library as presented in Table 1, assuming that the target home appliances corresponding to the clothes dryer type are a clothes dryer 1 and a clothes dryer 2; the target home appliance corresponding to the air conditioner type is an air conditioner 1; and the target home appliances corresponding to the washing machine type are a washing machine 1 and a washing machine 2, then the home appliance sets as combined are respectively: the clothes dryer 1, the air conditioner 1 and the washing machine 1; the clothes dryer 1, the air conditioner 1 and the washing machine 2; the clothes dryer 2, the air conditioner 1 and the washing machine 1; and the clothes dryer 2, the air conditioner 1 and the washing machine 2.

Each of the target home appliances in the home appliance set and the corresponding target home appliance label information can be output through the following manners:
1) displaying, through a visual interface, each of the target home appliances in the home appliance set and the corresponding target home appliance label information, so that the user can view, thereby improving the user experience;
2) sending each of the target home appliances in the home appliance set and the corresponding target home appliance label information to a terminal device for the terminal device to display.

According to the embodiment of the present application, the processing method for customizing a home appliance set includes: obtaining user related information; creating a home appliance set portrait of the user according to the user related information; calculating a similarity between the target label information corresponding to each of the types for the home appliances to be customized in the home appliance set portrait, and home appliance label information of each of home appliances in a preset home appliance label library, and obtaining from the home appliance label library, according to the similarity, a target home appliance corresponding to each of the types for the home appliances to be customized; modifying, according to the requirement information, customizable information of each of target home appliances to obtain target home appliance label information, as modified, of each of the target home appliances; combining all of the target home appliances to obtain a home appliance set as combined, and outputting each of the target home appliances in the home appliance set and the corresponding target home appliance label information. The presented solution can obtain user requirement information accurately, and improve accuracy and speed effectively for generating a home appliance set, thereby, satisfying a customization requirement of a user and providing, for various industries, more comprehensive and efficient support for marketing and iterative research and development.

It should be understood that the home appliance set as combined can be a single home appliance (a single home appliance item). Further, it may be a water ecological home appliance set, an air ecological home appliance set, or a temperature ecological home appliance set. Or even, it may be a home appliance set for a whole house. Thereby, special requirements of family members or living preferences of family members can be satisfied.

In an implementation, the electronic device can display, through the visual interface, each of the target home appliances in the home appliance set and the corresponding target home appliance label information in a three-dimensional (3-dimensional, 3D) manner based on house layout data of the user. The user can replace different home appliance sets in the visual interface based on his/her personal requirements until a satisfactory home appliance set (a target home appliance set) is selected and a click on a confirmation control is performed. The electronic device, in response to the user's click operation on the confirmation control, obtains the target home appliance set selected by the user, and interacts with a customization platform to distribute orders to suppliers, module vendors, and model production resource vendors of products to be customized with differential functions, respectively.

Compared with the existing technology, the present application changes from where a user selects products one by one based on product pages of traditional e-commerce, or selects products with the help of a shopping guide, into where an automatic selection to a home appliance set which best fits the requirements is made according to user characteristics, thereby, improving efficiency of searching for a product, and reducing costs for operations from human labor. The method provided in the embodiments of the present application can be implemented on various platforms and electronic devices, avoiding repeated development for the various platforms, and integrating the value of data output by the various platforms. Further, it can collect the target home appliance sets selected by users, analyze to dig out the most popular home appliance sets, and drive the development for new products based on large-scale user requirements, thereby, further optimizing structural arrangements of products, and further enhancing product competitiveness.

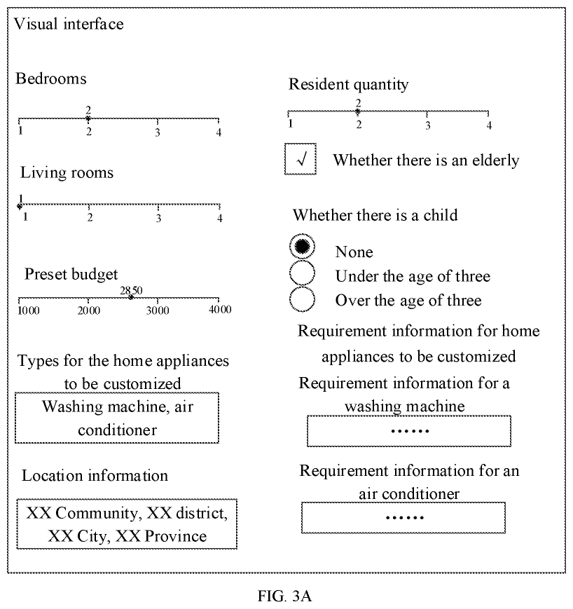

In another example, FIG. 4 is a schematic coordinate diagram of an air key performance indicator method according to an embodiment of the present application. As shown in FIG. 4, the detector may include a dust detector, a toxic gas probe, an oxygen content sensor, a formaldehyde detector, a temperature detector, a humidity detector, and a toxic gas detector. By means of incorporating the local air environment information captured by a meteorological station in an area where the user resides, and configuring detectors to collect data on temperature, humidity, cleanliness, and freshness, the corresponding functions of home appliances are activated in a coordinate manner.

FIG. 5 is a schematic flowchart in a second embodiment of a processing method for customizing a home appliance set according to an embodiment of the present application. As shown in FIG. 5, based on any one of the foregoing embodiments, S22 can be implemented through the following steps.

S51, performing emotion analysis on the question information and the requirement information for each of the types for the home appliances to be customized, to obtain emotion analysis grades for the types for the home appliances to be customized.

In a specific implementation, word segmentations can be extracted from the question information and the requirement information, and emotion analysis can be performed on the extracted word segmentations to obtain the emotion analysis grades.

The emotion analysis grades include a positive emotion grade and a negative emotion grade.

S52, obtaining, according to an emotion analysis grade for each of the types for the home appliances to be customized and the evaluation data, preference information of the user for the types for the home appliances to be customized.

In a specific implementation, the evaluation data can be subjected to processing to extract positive evaluation information and negative evaluation information from the evaluation data, and weighted processing can be performed on the positive emotion grade and the negative emotion grade in the emotion analysis grades, and on the positive evaluation information and the negative evaluation information in the evaluation data, to obtain the preference information.

S53, generating target label information corresponding to the types for the home appliances to be customized, according to preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user.

As an example, query, according to the location information of the user, local environmental pollution data, and generate the target label information of “environmental protection and energy efficiency take precedence” in cases of heavy local pollution.

In another example, when a resident is in a young age, generate, according to the house layout data and the population structure data of the residential house of the user, the target label information of “intelligent”, thereby, improving the safety and convenience of living in the house for the user.

In still another example, according to the historical order(s) and the browsing record(s), extract a commonality of various home appliances in the historical order(s) and the browsing record(s), and the “commonality” is used as the target label information. Assuming that clothes dryers in both of the browsing record(s) and the historical order(s) have a sterilization function, then the sterilization function is a potential purchasing requirement of the user, therefore, the “sterilization function” is determined to be the target label information, thereby, improving the accuracy of the generated home appliance set and improving the user experience.

S54, creating, according to each of the types for the home appliances to be customized and the corresponding target label information, the home appliance set portrait of the user.

In the foregoing embodiment, the target label information corresponding to the types for the home appliances to be customized is generated based on the user related information to create the home appliance set portrait of the user, which further improves the accuracy for creating the home appliance set portrait of the user, thereby, improving the accuracy of the obtained home appliance set.

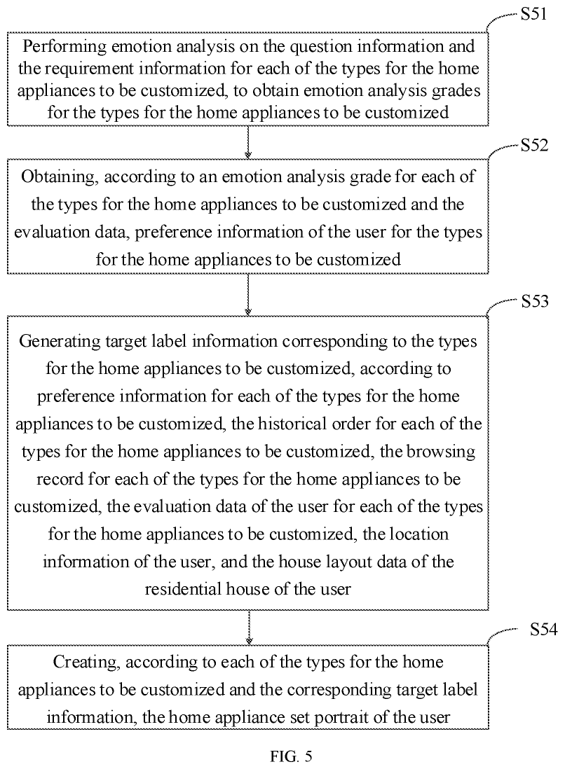

FIG. 6 is a schematic flowchart in a third embodiment of a processing method for customizing a home appliance set according to an embodiment of the present application. As shown in FIG. 6, based on any one of the foregoing embodiments, S53 can be implemented through the following steps.

S61, generating initial label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user.

For the implementation manner and the implementation principle of this step, reference can be made to S53, which will not be repeated here.

S62, obtaining, according to historical sales data of individual home appliances of each of the types for the home appliances to be customized and the initial label information, a selling popularity index corresponding to each piece of sub-label information in each piece of initial label information.

As an example, obtain, according to the initial label information, a historical sales volume of a home appliance which has any one piece of sub-label information in the initial label information, and perform processing on the historical sales volume and a total sales volume of the home appliance to obtain the selling popularity index corresponding to the piece of sub-label information.

As an example, with respect to a clothes dryer, if the sub-label information is “sterilization”, obtain a sales volume of all clothes dryers with a sterilization function, and determine a ratio of the sales volume to a total sales volume of clothes dryers to be the selling popularity index corresponding to sterilization.

S63, processing the initial label information according to the selling popularity index corresponding to each piece of sub-label information in each piece of initial label information, to generate the target label information.

In a specific implementation, a preset selling popularity index can be preset, and for each piece of initial label information, sub-label information with a selling popularity index smaller than the preset selling popularity index is deleted to generate the target label information.

As an example, assuming that the initial label information includes sub-label information 1, sub-label information 2, sub-label information 3 and sub-label information 4, the respective corresponding selling popularity indexes are 0.2, 0.3, 0.4, and 0.5, and the preset selling popularity index is 0.35, then discard the sub-label information 1 and the sub-label information 2 to obtain the target label information, where the target label information includes the sub-label information 3 and the sub-label information 4.

In the foregoing embodiment, a selling popularity index for each piece of sub-label information is calculated, permitting higher accuracy for generating the target label information, and further improving the accuracy for generating the home appliance sets as combined afterwards.

The following descriptions are apparatus embodiments of the present application, which can be used to execute the method embodiments of the present application. For details not disclosed in the apparatus embodiments of the present application, reference can be made to the method embodiments of the present application.

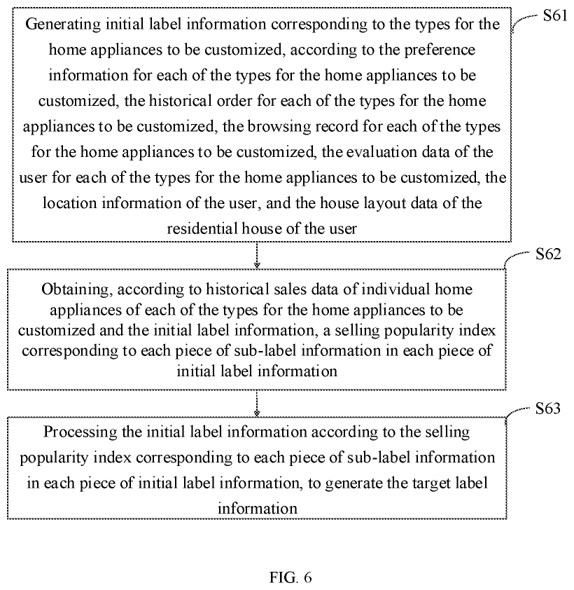

FIG. 7 is a schematic structural diagram of a processing apparatus for customizing a home appliance set according to an embodiment of the present application. As show in in FIG. 7, the processing apparatus for customizing a home appliance set includes:
an obtaining module 71, configured to obtain user related information, where the user related information includes a preset budget, at least two types for home appliances to be customized, question information of a user for each of the types for the home appliances to be customized, and requirement information of the user for each of the types for the home appliances to be customized;
a creating module 72, configured to create a home appliance set portrait of the user according to the user related information, where the home appliance set portrait includes the at least two types for the home appliances to be customized and at least one piece of target label information corresponding to each of the types for the home appliances to be customized; and
a processing module 73, configured to calculate a similarity between the target label information corresponding to each of the types for the home appliances to be customized in the home appliance set portrait, and home appliance label information of each of home appliances in a preset home appliance label library, and obtain from the home appliance label library, according to the similarity, a target home appliance corresponding to each of the types for the home appliances to be customized, where the home appliance label library includes multiple home appliances and the home appliance label information corresponding to each of the home appliances, where the home appliance label information includes budget information, function information, size information, appearance information and brand information, where at least one of the function information, the size information and the appearance information is customizable information;
where the processing module 73 is further configured to: modify, according to the requirement information, customizable information of each of target home appliances to obtain target home appliance label information, as modified, of each of the target home appliances; and
the processing module 73 is further configured to: combine all of the target home appliances to obtain a home appliance set as combined, and output each of the target home appliances in the home appliance set and the corresponding target home appliance label information.

In a possible design according to an embodiment of the present application, the user related information further includes a historical order for each of the types for the home appliances to be customized, a browsing record for each of the types for the home appliances to be customized, evaluation data of the user for each of the types for the home appliances to be customized, location information of the user, and house layout data of a residential house of the user;
correspondingly, the creating module 72 is specifically configured to:
   perform emotion analysis on the question information and the requirement information for each of the types for the home appliances to be customized, to obtain emotion analysis grades for the types for the home appliances to be customized;
obtain, according to an emotion analysis grade for each of the types for the home appliances to be customized and the evaluation data, preference information of the user for the types for the home appliances to be customized;
generate target label information corresponding to the types for the home appliances to be customized, according to preference information for each of types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user; and
create, according to each of the types for the home appliances to be customized and the corresponding target label information, the home appliance set portrait of the user.

In an implementation, the creating module 72 is specifically configured to: generate initial label information corresponding to the types for the home appliances to be customized, according to preference information for each of the types for the home appliances to be customized, a historical order for each of the types for the home appliances to be customized, a browsing record for each of the types for the home appliances to be customized, evaluation data of the user for each of the types for the home appliances to be customized, location information of the user, and house layout data of the residential house of the user;
obtain, according to historical sales data of individual home appliances of each of the types for the home appliances to be customized and the initial label information, a selling popularity index corresponding to each piece of sub-label information in each piece of initial label information; and
process the initial label information according to the selling popularity index corresponding to each piece of sub-label information in each piece of initial label information, to generate the target label information.

In another possible design according to an embodiment of the present application, the processing module 73 is specifically configured to:
determine a home appliance corresponding to the home appliance label information with the similarity exceeding a preset similarity to be the target home appliance.

In an implementation, when a number of the target home appliances is greater than or equal to 2, the processing module 73 is specifically configured to:
for the types for the home appliances to be customized that are different, determine any one target home appliance in each of the types for the home appliances to be customized to be a home appliance to be combined; and
combine all of home appliances to be combined to obtain multiple home appliance sets as combined.

In yet another possible design according to an embodiment of the present application, before obtaining the user related information, the obtaining module 71 is further configured to: obtain initial question information of the user for each of the types for the home appliances to be customized and initial requirement information of the user for each of the types for the home appliances to be customized; and the processing module 73 is further configured to: perform data cleaning and data normalization processing on the initial question information and the initial requirement information to obtain the question information and the requirement information.

In still another possible design according to an embodiment of the present application, the processing module 73 is specifically configured to: display, through a visual interface, each of the target home appliances in the home appliance set and the corresponding target home appliance label information.

The processing apparatus for customizing a home appliance set according to the embodiments of the present application can be used to execute the processing method for customizing a home appliance set according to any one of the foregoing embodiments, and the implementation principles and beneficial effects thereof are similar, which will not be repeated here.

It should be noted that, the partition of the various modules of the foregoing apparatus should be construed only as a logical function partition. In a practical implementation, some or all of the modules can be integrated into a physical entity, or they are physically separated. In addition, these modules can be implemented completely in the form of software called by a processing element; or they can also be implemented completely in the form of hardware; or they can be implemented partially in the form of software called by a processing element, and partially in the form of hardware. Moreover, all or part of these modules can be integrated in whole or implemented separately. The processing element mentioned herein can be an integrated circuit with signal processing capabilities. In an implementation process, each of the steps of the foregoing method or each of the foregoing modules can be completed through integrated logic circuits of hardware or instructions in the form of software in a processor element.

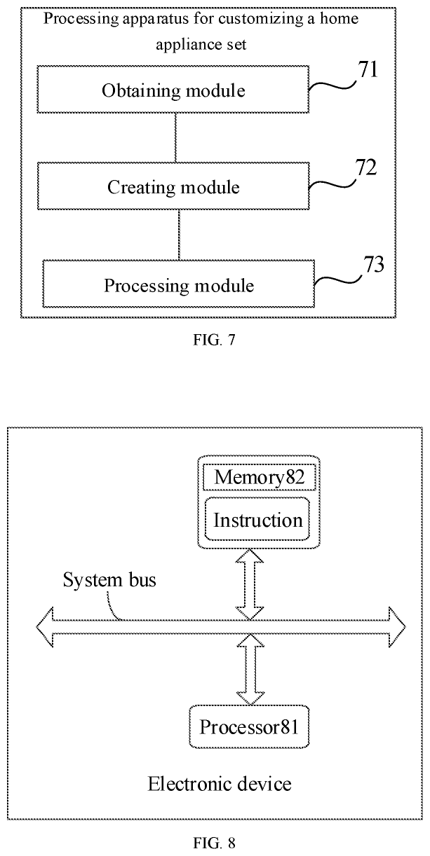

FIG. 8 is a schematic structural diagram of an electronic device according to an embodiment of the present application. As shown in FIG. 8, the electronic device can include: a processor 81 and a memory 82 and computer program instructions stored on the memory 82 and capable of running on the processor; where the processing method for customizing a home appliance set according to any of the foregoing embodiment is implemented when the computer program instructions are executed by the processor 81.

In an implementation, the electronic devices may further include an interface for interacting with other devices.

In an implementation, the foregoing components of the electronic device can be connected through a system bus.

The memory 82 can be a stand-alone storage unit or a storage unit integrated in the processor. The processor is singular or plural in number.

It should be understood that the processor 81 can be a central processing unit (Central Processing Unit, CPU), or other general purpose processors, digital signal processors (Digital Signal Processors, DSP), application specific integrated circuits (Application Specific Integrated Circuit, ASIC), etc. A general purpose processor can be a microprocessor or any conventional processor etc. The steps of the method disclosed in the present application can be directly embodied as being implemented through hardware processor execution, or through the execution of hardware and software modules in the processor in combination.

The system bus can be a peripheral component interconnect (peripheral component interconnect, PCI) bus or an extended industry standard architecture (extended industry standard architecture, EISA) bus etc. The system bus can be divided into an address bus, a data bus, a control bus, etc. For ease of representation, it is presented using only one thick line in the drawing, however, it does not mean that there is only one bus or one type of bus. The memory may include a random access memory (random access memory, RAM) or a non-volatile memory (non-volatile memory, NVM), such as at least one disk storage.

All or some of the steps implementing the foregoing various method embodiments can be implemented through program instruction related hardware. The mentioned program can be stored in a readable memory. When the program is executed, the steps including the foregoing method embodiments are implemented. The foregoing memory (storage medium) includes: a read-only memory (read-only memory, ROM), a RAM, a flash memory, a hard disk, a solid-state drive, a magnetic tape (English: magnetic tape), a floppy disk (English: floppy disk), an optical disc (English: optical disc), or any combination thereof.

The electronic device according to the embodiments of the present application can be used to execute the processing method for customizing a home appliance set according to any one of the foregoing embodiments, and the implementation principles and beneficial effects thereof are similar, which will not be repeated here.

An embodiment of the present application provides a computer-readable storage medium. The computer-readable storage medium stores thereon computer instructions which, when running on a computer, enable the computer to execute the foregoing processing method for customizing a home appliance set.

The foregoing computer readable storage medium can be implemented by any type of volatile or non-volatile storage device or a combination thereof, such as a static random access memory, an electrically erasable programmable read-only memory, an erasable programmable read-only memory, a programmable read-only memory, a read-only memory, a magnetic memory, a flash memory, a magnetic disk or an optical disc. The readable storage medium can be any available medium that can be accessed by a general-purpose or dedicated computer.

In an implementation, the readable storage medium is coupled to the processor, enabling the processor to read information from and write information to the readable storage medium. Naturally, the readable storage medium can also be a component of the processor. The processor and the readable storage medium can be provided in Application Specific Integrated Circuits (Application Specific Integrated Circuits, ASIC). Naturally, the processor and the readable storage medium can also exist in a device as stand-alone components.

An embodiment of the present application further provides a computer program product. The computer program product includes a computer program stored in a computer readable storage medium. At least one processor can read the computer program from the computer readable storage medium, and the processing method for customizing an appliance set can be implemented when the at least one processor executes the computer program.

An embodiment of the present application further provides a chip including a memory and a processor. The memory stores thereon codes and data, and is coupled to the processor. The processor runs a program in the memory to enable the chip to execute the processing method for customizing an appliance set according to the foregoing various embodiments.

An embodiment of the present application further provides a computer program, where the computer program is configured to, when being executed by a processor, execute the processing method for customizing an appliance set according to the foregoing various embodiments.

Finally, it should be noted that the foregoing various embodiments are only intended to explain the technical solution of the present application and shall not be construed as limitation. Although the present application has been described in considerable details with reference to the foregoing embodiments, those ordinarily skilled in the art should understand that modifications can be made to the technical solution of the present application, or some or all technical features thereof may be substituted by their equivalents, and such modifications or substitutions do not cause the essence of the technical solution to deviate from the scope of the technical solution of the embodiments according to the present application.

1. A processing method for customizing a home appliance set, comprising:
obtaining user related information, wherein the user related information comprises a preset budget, at least two types for home appliances to be customized, question information of a user for each of the types for the home appliances to be customized, and requirement information of the user for each of the types for the home appliances to be customized;
creating a home appliance set portrait of the user according to the user related information, wherein the home appliance set portrait comprises the at least two types for the home appliances to be customized and at least one piece of target label information corresponding to each of the types for the home appliances to be customized;
calculating a similarity between the target label information corresponding to each of the types for the home appliances to be customized in the home appliance set portrait, and home appliance label information of each of home appliances in a preset home appliance label library, and obtaining from the home appliance label library, according to the similarity, a target home appliance corresponding to each of the types for the home appliances to be customized, wherein the home appliance label library comprises multiple home appliances and the home appliance label information corresponding to each of the home appliances, wherein the home appliance label information comprises budget information, function information, size information, appearance information and brand information, wherein at least one of the function information, the size information and the appearance information is customizable information;
modifying, according to the requirement information, customizable information of each of target home appliances to obtain target home appliance label information, as modified, of each of the target home appliances; and
combining all of the target home appliances to obtain a home appliance set as combined, and outputting each of the target home appliances in the home appliance set and the corresponding target home appliance label information.

2. The method according to claim 1, wherein the user related information further comprises a historical order for each of the types for the home appliances to be customized, a browsing record for each of the types for the home appliances to be customized, evaluation data of the user for each of the types for the home appliances to be customized, location information of the user, and house layout data of a residential house of the user;
correspondingly, creating the home appliance set portrait of the user according to the user related information, comprises:
performing emotion analysis on the question information and the requirement information for each of the types for the home appliances to be customized, to obtain emotion analysis grades for the types for the home appliances to be customized;
obtaining, according to an emotion analysis grade for each of the types for the home appliances to be customized and the evaluation data, preference information of the user for the types for the home appliances to be customized;
generating target label information corresponding to the types for the home appliances to be customized, according to preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user; and
creating, according to each of the types for the home appliances to be customized and the corresponding target label information, the home appliance set portrait of the user.

3. The method according to claim 2, wherein generating the target label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user, comprises:
generating initial label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user;
obtaining, according to historical sales data of individual home appliances of each of the types for the home appliances to be customized and the initial label information, a selling popularity index corresponding to each piece of sub-label information in each piece of initial label information; and
processing the initial label information according to the selling popularity index corresponding to each piece of sub-label information in each piece of initial label information, to generate the target label information.

4. The method according to claim 1, wherein obtaining from the home appliance label library, according to the similarity, the target home appliance corresponding to each of the types for the home appliances to be customized, comprises:
determining a home appliance corresponding to the home appliance label information with the similarity exceeding a preset similarity to be the target home appliance.

5. The method according to claim 1, wherein, when a number of the target home appliances is greater than or equal to 2, combining all of the target home appliances to obtain the home appliance set as combined, comprises:
for the types for the home appliances to be customized that are different, determining any one target home appliance in each of the types for the home appliances to be customized to be a home appliance to be combined; and
combining all of home appliances to be combined to obtain multiple home appliance sets as combined.

6. The method according to claim 1, wherein, before obtaining the user related information, the method further comprises:
obtaining initial question information of the user for each of the types for the home appliances to be customized and initial requirement information of the user for each of the types for the home appliances to be customized; and
performing data cleaning and data normalization processing on the initial question information and the initial requirement information to obtain the question information and the requirement information.

7. The method according to claim 1, wherein outputting each of the target home appliances in the home appliance set and the corresponding target home appliance label information, comprises:
displaying, through a visual interface, each of the target home appliances in the home appliance set and the corresponding target home appliance label information.

8. (canceled)

9. An electronic device, comprising a processor, a memory and computer program instructions stored on the memory; wherein the computer program instructions, when being executed by the processor, enable the processor to:
obtain user related information, wherein the user related information comprises a preset budget, at least two types for home appliances to be customized, question information of a user for each of the types for the home appliances to be customized, and requirement information of the user for each of the types for the home appliances to be customized;
create a home appliance set portrait of the user according to the user related information, wherein the home appliance set portrait comprises the at least two types for the home appliances to be customized and at least one piece of target label information corresponding to each of the types for the home appliances to be customized;
calculate a similarity between the target label information corresponding to each of the types for the home appliances to be customized in the home appliance set portrait, and home appliance label information of each of home appliances in a preset home appliance label library, and obtain from the home appliance label library, according to the similarity, a target home appliance corresponding to each of the types for the home appliances to be customized, wherein the home appliance label library comprises multiple home appliances and the home appliance label information corresponding to each of the home appliances, wherein the home appliance label information comprises budget information, function information, size information, appearance information and brand information, wherein at least one of the function information, the size information and the appearance information is customizable information;
modify, according to the requirement information, customizable information of each of target home appliances to obtain target home appliance label information, as modified, of each of the target home appliances; and
combine all of the target home appliances to obtain a home appliance set as combined, and output each of the target home appliances in the home appliance set and the corresponding target home appliance label information.

10. A non-transitory computer-readable storage medium, storing thereon, computer executable instructions which are configured to, when being executed by a processor, implement the steps of:
obtaining user related information, wherein the user related information comprises a preset budget, at least two types for home appliances to be customized, question information of a user for each of the types for the home appliances to be customized, and requirement information of the user for each of the types for the home appliances to be customized;
creating a home appliance set portrait of the user according to the user related information, wherein the home appliance set portrait comprises the at least two types for the home appliances to be customized and at least one piece of target label information corresponding to each of the types for the home appliances to be customized;
calculating a similarity between the target label information corresponding to each of the types for the home appliances to be customized in the home appliance set portrait, and home appliance label information of each of home appliances in a preset home appliance label library, and obtaining from the home appliance label library, according to the similarity, a target home appliance corresponding to each of the types for the home appliances to be customized, wherein the home appliance label library comprises multiple home appliances and the home appliance label information corresponding to each of the home appliances, wherein the home appliance label information comprises budget information, function information, size information, appearance information and brand information, wherein at least one of the function information, the size information and the appearance information is customizable information;
modifying, according to the requirement information, customizable information of each of target home appliances to obtain target home appliance label information, as modified, of each of the target home appliances; and
combining all of the target home appliances to obtain a home appliance set as combined, and outputting each of the target home appliances in the home appliance set and the corresponding target home appliance label information.

11. (canceled)

12. A chip, comprising a memory and a processor, the memory storing thereon codes and data, and being coupled to the processor, wherein the processor runs a program in the memory to enable the chip to implement the processing method for customizing a home appliance set according to claim 1.

13. (canceled)

14. The electronic device according to claim 9, wherein the user related information further comprises a historical order for each of the types for the home appliances to be customized, a browsing record for each of the types for the home appliances to be customized, evaluation data of the user for each of the types for the home appliances to be customized, location information of the user, and house layout data of a residential house of the user;
the computer program instructions enable the processor to:
perform emotion analysis on the question information and the requirement information for each of the types for the home appliances to be customized, to obtain emotion analysis grades for the types for the home appliances to be customized;
obtain, according to an emotion analysis grade for each of the types for the home appliances to be customized and the evaluation data, preference information of the user for the types for the home appliances to be customized;
generate target label information corresponding to the types for the home appliances to be customized, according to preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user; and
create, according to each of the types for the home appliances to be customized and the corresponding target label information, the home appliance set portrait of the user.

15. The electronic device according to claim 14, wherein the computer program instructions enable the processor to:
generate initial label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user;
obtain, according to historical sales data of individual home appliances of each of the types for the home appliances to be customized and the initial label information, a selling popularity index corresponding to each piece of sub-label information in each piece of initial label information; and
process the initial label information according to the selling popularity index corresponding to each piece of sub-label information in each piece of initial label information, to generate the target label information.

16. The electronic device according to claim 9, wherein the computer program instructions enable the processor to:
determine a home appliance corresponding to the home appliance label information with the similarity exceeding a preset similarity to be the target home appliance.

17. The electronic device according to claim 9, wherein a number of the target home appliances is greater than or equal to 2, and the computer program instructions enable the processor to:
for the types for the home appliances to be customized that are different, determine any one target home appliance in each of the types for the home appliances to be customized to be a home appliance to be combined; and
combine all of home appliances to be combined to obtain multiple home appliance sets as combined.

18. The electronic device according to claim 9, wherein the computer program instructions further enable the processor to:
obtain initial question information of the user for each of the types for the home appliances to be customized and initial requirement information of the user for each of the types for the home appliances to be customized; and
perform data cleaning and data normalization processing on the initial question information and the initial requirement information to obtain the question information and the requirement information.

19. The electronic device according to claim 9, wherein the computer program instructions enable the processor to:
display, through a visual interface, each of the target home appliances in the home appliance set and the corresponding target home appliance label information.

20. The storage medium according to claim 10, wherein the user related information further comprises a historical order for each of the types for the home appliances to be customized, a browsing record for each of the types for the home appliances to be customized, evaluation data of the user for each of the types for the home appliances to be customized, location information of the user, and house layout data of a residential house of the user;
the computer executable instructions are configured to implement the steps of:
performing emotion analysis on the question information and the requirement information for each of the types for the home appliances to be customized, to obtain emotion analysis grades for the types for the home appliances to be customized;
obtaining, according to an emotion analysis grade for each of the types for the home appliances to be customized and the evaluation data, preference information of the user for the types for the home appliances to be customized;
generating target label information corresponding to the types for the home appliances to be customized, according to preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user; and
creating, according to each of the types for the home appliances to be customized and the corresponding target label information, the home appliance set portrait of the user.

21. The storage medium according to claim 20, wherein the computer executable instructions are configured to implement the steps of:
generating initial label information corresponding to the types for the home appliances to be customized, according to the preference information for each of the types for the home appliances to be customized, the historical order for each of the types for the home appliances to be customized, the browsing record for each of the types for the home appliances to be customized, the evaluation data of the user for each of the types for the home appliances to be customized, the location information of the user, and the house layout data of the residential house of the user;
obtaining, according to historical sales data of individual home appliances of each of the types for the home appliances to be customized and the initial label information, a selling popularity index corresponding to each piece of sub-label information in each piece of initial label information; and
processing the initial label information according to the selling popularity index corresponding to each piece of sub-label information in each piece of initial label information, to generate the target label information.

22. The storage medium according to claim 10, wherein the computer executable instructions are configured to implement the steps of:
determining a home appliance corresponding to the home appliance label information with the similarity exceeding a preset similarity to be the target home appliance.

23. The storage medium according to claim 10, wherein a number of the target home appliances is greater than or equal to 2, and the computer executable instructions are configured to implement the steps of:
for the types for the home appliances to be customized that are different, determining any one target home appliance in each of the types for the home appliances to be customized to be a home appliance to be combined; and
combining all of home appliances to be combined to obtain multiple home appliance sets as combined.
